(19) United States
(12) Patent Application Publication
(10) Pub. No.: US 2007/0215058 A1
(43) Pub. Date: Sep. 20, 2007

(54) Cat litter box cleaning system

(76) Inventor: Eleanor French Spreitzer, Columbus, OH (US)

Correspondence Address: GALLAGHER & DAWSEY CO., L.P.A., P.O. BOX 785, COLUMBUS, OH, 43216, US

(21) Appl. No.: 11/384,086

(22) Filed: Mar. 17, 2006

(51) Int. Cl. A01K 29/00

(52) U.S. Cl. 119/166

(57) ABSTRACT

A cat litter box cleaning system designed to sieve waste clumps from cat litter. The cat litter box cleaning system has multiple layers thereby providing multiple cleaning operations. The layers consist of a sieving layer and a liner. The liner shields the sieving layer from the cat's claws and the sieving layer is used to remove the waste from the litter. Each sieving layer and liner releasably cooperates with the layer securing fixtures. The layer securing fixtures releasably attach the layers to a base and prevent the cat from dislodging the sieves or liners. The cat litter box cleaning system contemplates the use of disposable or reusable liners. The reusable liners may be stored in a storage compartment. In addition, the cat litter box cleaning system may include a rim releasably attached to the posts to help contain any litter that becomes airborne while the cat covers its waste.

### TECHNICAL FIELD

The instant invention relates to systems for sieving solidified waste from granular material to dispose of the waste and reuse the granular material, and, more particularly, to a cat litter cleaning system having a base with sides, a layer fixture system for retaining multiple alternating layers of sieves for removing the waste from the litter and liners for protecting the sieves from a cat's claws.

### BACKGROUND OF THE INVENTION

Pet owners know that part of being a responsible pet owner is providing for their pet's needs. Cats are popular domestic pets, and like many other pets, they spend time indoors. Most cat owners provide a litter box in the home. The litter box serves as a place for the cat to relieve themselves. The litter box is filled with cat litter. Cat litter is available in many brands and can vary by function. Types of cat litter include specially treated recycled paper; all natural litter, so if the cat eats it, the cat will not be sickened; and other types that serve a specific purpose. For example, there is cat litter containing an additive that changes color depending on the acidity of the cat's urine and is used for determining if the cat has a urinary tract infection. Cat litter has numerous other and more common functions. Mainly, it helps eliminate the odor from feces and urine and therefore helps keep the home from smelling like cat waste. Cat litter is usually composed of many individual particles or granules. The individual granules clump together in the presence of urine or feces, absorbing the fluids and odor. The clumping ability varies by litter type and, because of its importance, clumping can be a selling point for pet owners.

The odor reduction extends the time between cleanings. However, eventually the continued use of the litter box overwhelms the cat litter. Therefore, the litter must be frequently cleaned and fresh litter added or the litter must be dumped and replaced. For litter boxes having clumping litter, cleaning the litter box consists essentially of removing the clumps of urine and feces. The clumping action of the litter is important to cat owners because it makes cleaning less difficult. In particular, hard clumps make cleaning the litter box easier. The simplest way to remove the clumps of waste is to dig each of the clumps out with a spoon. A harder clump is more durable and resists break down when handled. In any event, digging out the waste clumps becomes a never-ending, dirty task.

There remains an unfulfilled need to provide a cat litter cleaning system which is cost effective to manufacture, easy and convenient to use, reduces the time spent cleaning cat waste out of the litter, and is hygienically designed.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

The cat litter box cleaning system provides a method for conveniently removing a cat's waste from litter. The waste clumps are an aggregate of the litter granules agglomerated by urine, feces, or a combination of both. The waste clumps are larger than the individual litter granules making removal of the waste clumps possible with a sieve.

A base has a granule contact surface, a base perimeter, and at least two layer securing fixtures. The base perimeter has a wall extending at a substantially perpendicular angle to the granule contact surface to a wall height, and the layer securing fixtures are located within the base perimeter. The cat litter box cleaning system has a first layer.

The first layer has a first sieve and a first liner. The first sieve has at least two first sieve securing receptacles. The first sieve may be formed with a plurality of similarly sized openings. The openings should be large enough to allow unused litter granules to pass through the openings while at the same time prohibiting waste clumps from passing through the openings.

The first liner has at least two first liner securing receptacles, a first liner granule contact surface, a first liner bottom surface, and a first liner perimeter. The first liner shields the first sieve from the cat. The first sieve perimeter and the first liner perimeter are substantially the same shape and size as the base perimeter. The first liner may be a sheet of material that covers the first sieve.

The first sieve and the first liner are assembled in a specific order. The first sieve is placed within the base with each first sieve securing receptacle being releasably attached to one layer securing fixture. Once in position, the first sieve bottom surface is adjacent to the base granule contact surface. The first liner is inserted into the base with one first liner securing receptacle being releasably attached to one layer securing fixture. The first liner bottom surface is adjacent to the first sieving surface.

The first sieve and the first liner are secured in position by the layer securing fixtures. Once the first sieve and the first liner are secured into position, the litter granules are added.

The cat will eventually eliminate in the litter. The litter granules will adhere to the waste forming the waste clumps. At some point the owner will clean the cat litter by removing the waste clumps. In an embodiment of the instant invention having the first layer, the owner will first disconnect the first liner from the layer securing fixture. The owner will then dump the litter, including the waste clumps, from the first liner onto the first sieving surface. The owner removes the first liner for disposal or storage, as will be discussed below. The first sieve securing receptacles are released from the layer securing fixtures while the litter granules and the waste clumps are on the first sieving surface. By lifting the first sieve from the base, the litter granules pass through the first sieve and onto the granule contact surface, which leaves the waste clumps on the first sieving surface. The owner can then dispose of the waste clumps.

In another embodiment of the instant invention, the cat litter box cleaning system has a plurality of layers. In one embodiment, allowing for daily changes in a weekly cycle, in addition to the first layer described above, the system would have six additional layers, a second, a third, a fourth, a fifth, a sixth, and a seventh. Each of the sieves has similar features to the first sieve and each of the liners has similar features to the first liner.

In another embodiment of the present invention, the layer securing fixtures are posts having a securing fixture height and a cross section that cooperates with a human finger. In another embodiment of the present invention, the base has a liner storage compartment to releasably house the liners.

In yet another embodiment of the instant invention, the wall may be formed with gripping alcoves. The gripping alcoves may cooperate with the layer securing fixtures. The owner may easily place a hand into the gap created by the gripping alcove to grasp the liner or the sieve in question.

In yet another embodiment of the instant invention, the sieves have a sieve gripping extension and the liners have liner gripping extensions. The sieve gripping and liner gripping extensions are attached to the sieve and liner perimeters and extend upwards along the wall out of the litter granules. In another embodiment of the instant invention, the first sieve gripping extensions are sieve gripping extension tabs and the liner gripping extensions are liner gripping extension tabs to further ease sieve and liner removal.

The cat litter box cleaning system of the instant invention enables a significant advance in the state of the art. Variations, modifications, alternatives, and alterations of the various preferred embodiments may be used alone or in combination with one another, as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures:

FIG. 1 is an isometric view of an embodiment of the cat litter cleaning system showing the base and a first layer, not to scale;

FIG. 2 is an isometric view of an embodiment of the instant invention showing the base and assembly of the first layer, not to scale;

FIG. 3 is an isometric view of an embodiment of the instant invention showing final assembly of the first layer and filling with litter, not to scale;

FIG. 4 is an isometric view of an embodiment of the instant invention showing withdrawal of a first liner with litter granules and waste clumps, not to scale;

FIG. 5 is an isometric view of an embodiment of the instant invention showing the dumping of the litter granules and waste clumps onto a first sieve, not to scale;

FIG. 6 is an isometric view of an embodiment of the instant invention showing withdrawal of the first sieve with the waste clumps retained on the first sieve, not to scale;

FIG. 7 is an isometric view of an embodiment of the instant invention with a plurality of first sieve and first liner gripping extensions, not to scale;

FIG. 8 is a top plan view of an embodiment of the instant invention with half-moon shaped layer securing fixtures, not to scale;

FIG. 9 is an isometric view of an embodiment of the instant invention with a protective rim and a liner storage compartment, not to scale;

FIG. 10 is a cross-sectional view of the protective rim taken along section line 10-10 in FIG. 9, not to scale;

FIG. 11 is an isometric view of an embodiment of the instant invention with rectangular shaped layer securing fixtures and rectangular shaped first sieve securing receptacles and rectangular shaped first liner securing receptacles, not to scale;

FIG. 12 is a top plan view of an embodiment of a liner with rectangular shaped liner securing receptacles, not to scale;

FIG. 13 is a top plan view of an embodiment of a sieve with rectangular shaped sieve securing receptacles, not to scale;

FIG. 14 is a top plan view of an embodiment of a base with rectangular shaped layer securing fixtures; not to scale;

FIG. 15 is an isometric view of an embodiment of the instant invention with a storage cover, not to scale;

FIG. 16 is an isometric view of a disposable liner with fold lines, not to scale;

FIG. 17 is an isometric view of an embodiment of the instant invention with liner and sieve gripping extensions, not to scale;

FIG. 18 is an isometric view of an embodiment of the instant invention showing seven layers of liners and sieves, not to scale; and

FIG. 19 is an isometric view of an embodiment of the instant invention showing seven layers of liners and sieves, not to scale.

### DETAILED DESCRIPTION OF THE INVENTION

A cat litter box cleaning system (100) of the instant invention enables a significant advance in the state of the art. The preferred embodiments of the device accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

The cat litter box cleaning system (100) of the instant invention provides a method for conveniently removing a cat's waste from a plurality of litter granules (10). As one skilled in the art will recognize, litter granules (10) are available in many types. Litter granules (10) may be specially processed recycled paper products, clay minerals, “all natural” materials, and other proprietary mixes. Many types of litter granules (10) form “waste clumps” (20). The waste clumps (20) are agglomerations of the litter granules (10) adhered together by urine, feces, or a combination of both. The waste clumps (20) are larger than the individual litter granules. A sieve can be used to remove the waste clumps (20) due to the relative size difference between the waste clumps (20) and the litter granules (10).

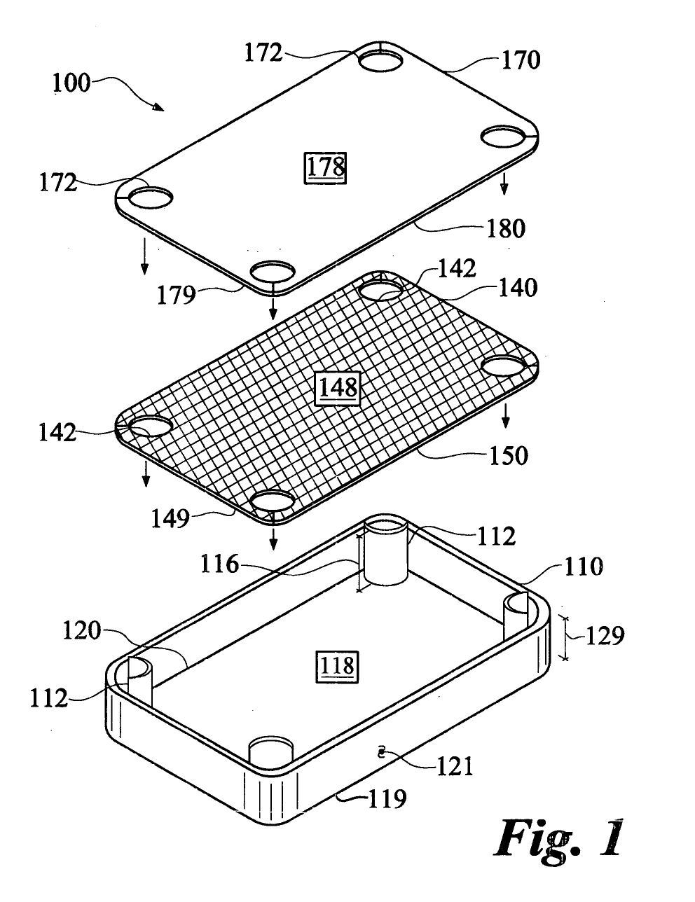

In one embodiment of the instant invention, as seen in FIG. 1, a base (110) has a granule contact surface (118), a base perimeter (120), a support surface (119), and at least two layer securing fixtures (112). Generally, the cat litter cleaning system (100) is placed with the support surface (119) in contact with a floor or other horizontal surface. The base perimeter (120) has a wall (121) extending at a substantially perpendicular angle from the granule contact surface (118) to a wall height (129). The layer securing fixtures (112) are located within the base perimeter (120). The layer securing fixtures (112) will be described in more detail below.

As one skilled in the art will appreciate, the layer securing fixtures (112), the base (110), and the wall (121) may be formed as a unitary body. In another embodiment of the instant invention, the layer securing fixtures (112) may be separate structures attached to the base (110) with screws, glue, or other fasteners capable of anchoring the layer securing fixtures (112) to the base (110). In yet another embodiment of the instant invention, the base (110), the wall (121), and the layer securing fixtures (112) may be made out of heavy plastic. The wall height (129) may be between approximately three and approximately twelve inches, and may be limited only by the height the cat is willing to jump. With continued reference to FIG. 1, the cat litter box cleaning system (100) has a first layer. The first layer has a first sieve (140) and a first liner (170).

The first sieve (140) has at least two first sieve securing receptacles (142), a first sieving surface (148), a first sieve bottom surface (149), and a first sieve perimeter (150). The number of the first sieve securing receptacles (142) is greater than or equal to the number of layer securing fixtures (112). The first sieve securing receptacles (142) align with the layer securing fixtures (112) so that one first sieve securing receptacle (142) is positioned to cooperate with one layer securing fixture (112) in a such a manner that the first sieve perimeter (150) and the base perimeter (120) are substantially coincident. As one skilled in the art will recognize, the first sieve (140) is formed with a plurality of similarly sized openings extending from the first sieving surface (148) to the first sieve bottom surface (149). The first sieve (140) may be made by weaving monofilament fibers or by stamping openings in a solid sheet. Thus, the first sieve (140) may be rigid or flexible. The openings may be any shape, and are large enough to allow unused litter granules (10) to pass through the openings while, at the same time, prohibiting waste clumps (20) from passing through the openings. The first sieve perimeter (150) may be substantially the same as the base perimeter (120).

With continued reference to FIG. 1, the first liner (170) has at least two first liner securing receptacles (172), a first liner granule contact surface (178), a first liner bottom surface (179), and a first liner perimeter (180). Although the number of first liner securing receptacles (172) may be equal to the number of layer securing fixtures (112), as shown in FIG. 1, the number of first liner securing receptacles may be greater than the number of layer securing fixtures (112). The positions of the first liner securing receptacles (172) align with the layer securing fixtures (112) so that one first liner securing receptacle (172) is positioned to cooperate with one layer securing fixture (112) in such a manner that the first liner perimeter (180) and the base perimeter (120) are substantially adjacent. As one skilled in the art will appreciate, the first sieve securing receptacles (142) need not be the same type of receptacle as the first liner securing receptacles (172). In one embodiment of the instant invention, the first sieve securing receptacle (142) is a reinforced hole that releasably cooperates with the layer securing fixture (112) and the first liner securing receptacle (172) is an expandable, elastic noose that frictionally grips the layer securing fixture (112). In another embodiment of the instant invention, as seen in FIG. 1, the first sieve (140) has precut areas that extend from the first sieve securing receptacles (142) to the first sieve perimeter (150) and the first liner (170) has precut areas that extend from the first liner securing receptacles (172) to the first liner perimeter (180). The precut areas may permit easy removal of the first sieve (140) and the first liner (170) past the layer securing fixtures (112).

Both the first sieve (140) and the first liner (170) are held in position by at least two layer securing fixtures (112). As previously mentioned, the layer securing fixtures (112) are positioned within the base perimeter (120). The layer securing fixtures (112) substantially prevent the cat from dislodging or moving the first liner (170) relative to the base (110) or relative to the first sieve (140). If the cat is able to move the first liner (170), the first sieve (140) may be damaged, or otherwise compromised. In either case, the functioning of the cat litter cleaning system (100) may be inhibited. As one skilled in the art will recognize, more than two layer securing fixtures (112) may also hold the first liner (170) and first sieve (140) in position. The positioning of the layer securing fixtures (112) is such that any translational force exerted by the cat on the first liner (170) or the first sieve (140) is resisted by at least one layer securing fixture (112) thereby substantially preventing the first liner (170) or the first sieve (140) from being substantially dislodged.

One purpose of the first liner (170) is to shield the first sieve (140) from the cat, particularly the cat's claws. The first liner (170) may be a sheet of flexible or rigid material. The material may be cardboard, plastic, heavy aluminum foil, treated wood, or other urine or feces resistant material. The material may also be resistant to occasional clawing when the cat manages to get its claws in contact with the first liner (170). In another embodiment of the instant invention, the first liner (170) has a smooth surface texture to prevent the cat from snagging their claws on the first liner granule contact surface (178).

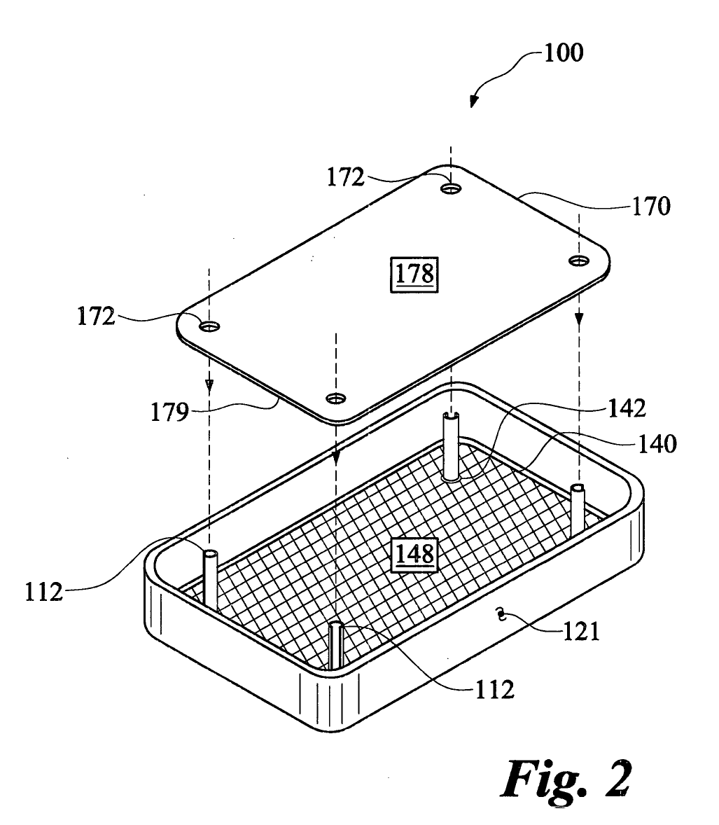

The first sieve (140) and the first liner (170) are assembled in a specific order. As seen in FIG. 2, the first sieve (140) is placed within the base (110) with one first sieve securing receptacles (142) releasably cooperating with one layer securing fixture (112). Once in position, the first sieve bottom surface (149) is adjacent to the base granule contact surface (118). Following a similar assembly procedure, the first liner (170) is inserted into the base (110) with one first liner securing receptacle (172) releasably cooperating with one layer securing fixture (112). When installed, the first liner bottom surface (179) is adjacent to the first sieving surface (148).

The first sieve (140) and the first liner (170) are secured in position by the releasable cooperation of the first sieve securing receptacles (142) and the first liner sieve securing receptacles (172) with the layer securing fixtures (112), thus substantially preventing the cat from dislodging or disturbing the first sieve (140) and the first liner (170) within the base (110). Therefore, the first sieve and liner perimeters (150, 180) are maintained in position adjacent to the wall (121) helping keep the litter granules (10) and waste clumps (20) on the first liner granule contact surface (178). As those skilled in the art will recognize, the layer securing fixtures (112) may be elastic cord, rope, rods, and structure capable of releasably attaching to the first sieve (140) and first liner (170).

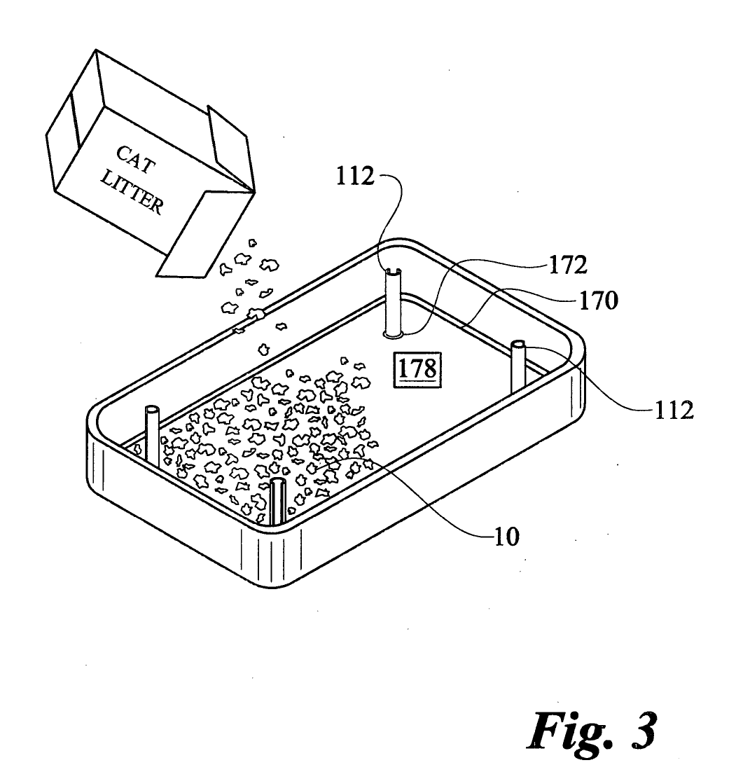

As seen in FIG. 3, once the first sieve (140) and the first liner (170) are secured into position, the litter granules (10) are added onto the first liner granule contact surface (178). The litter granules (10) may form a layer of litter between approximately one and approximately four inches deep. If the cat were to dig through the litter granules (10) to the first liner granule contact surface (178) then the cat would be unable to dislodge the first liner (170) or the first sieve (140).

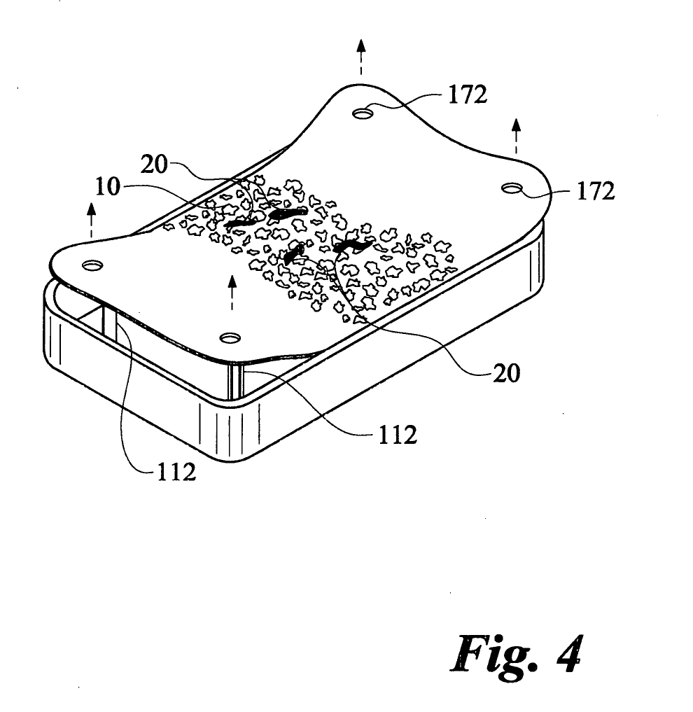

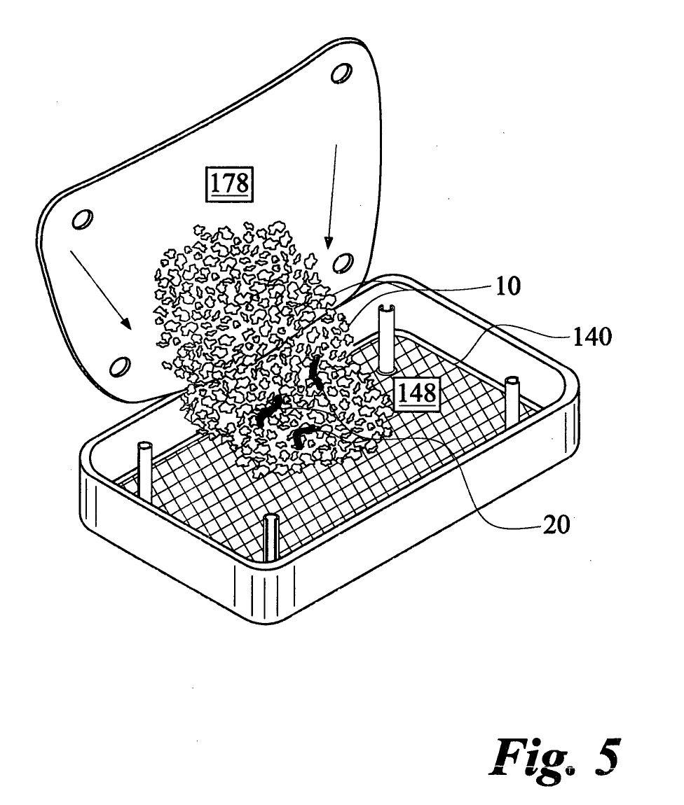

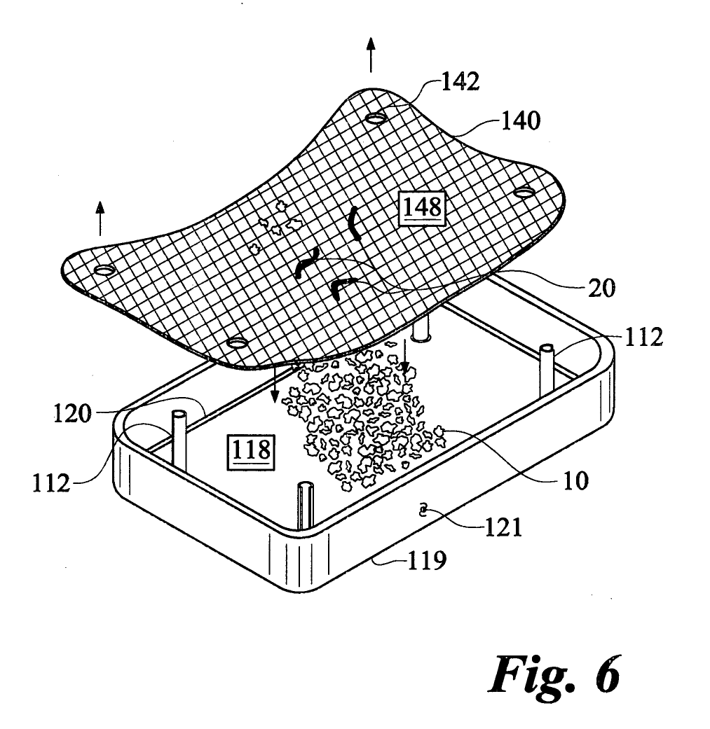

The cat will eventually eliminate in the layer of litter. The litter granules (10) will adhere to the waste forming the waste clumps (20). At some point, the owner will clean the litter granules (10) by removing the waste clumps (20). In an embodiment of the instant invention having the first layer, as seen in FIG. 4, the owner will first disconnect the first liner (170) from the layer securing fixtures (112). The owner will then dump the litter, including the waste clumps (20), from the first liner (170) onto the first sieving surface (148), as seen in FIG. 5. The owner removes the first liner (170) for disposal or storage, as will be discussed below. As seen in FIG. 6, the first sieve securing receptacles (142) are released from the layer securing fixtures (112) while the litter granules (10) and the waste clumps (20) are on the first sieving surface (148). By lifting the first sieve (140) from the base (110), the litter granules (10) pass through the first sieve (140) and onto the granule contact surface (118), but the first sieve (140) captures the waste clumps (20) on the first sieving surface (148). The owner can then dispose of the waste clumps (20).

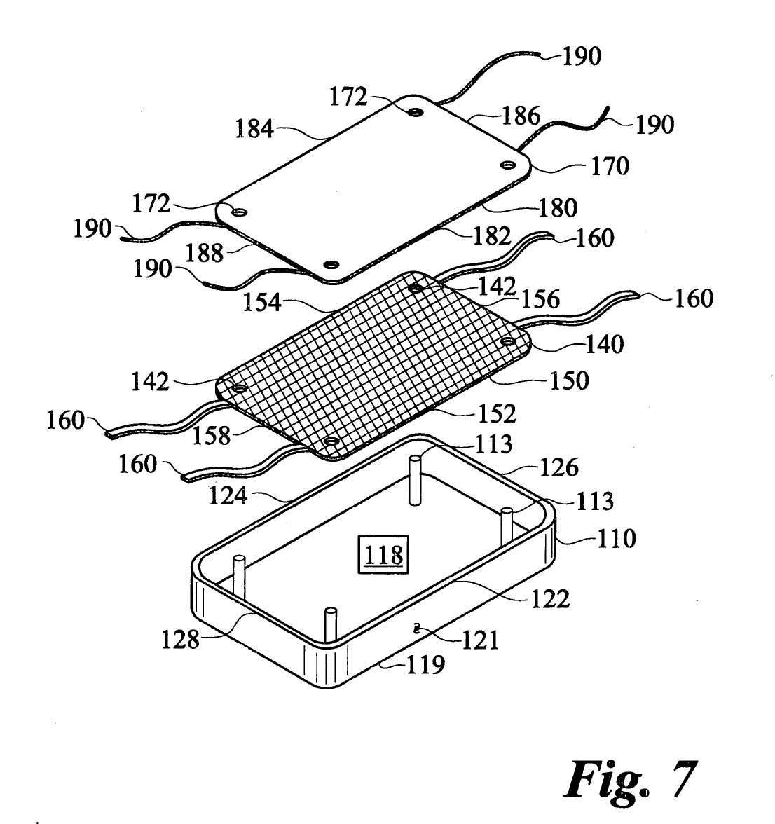

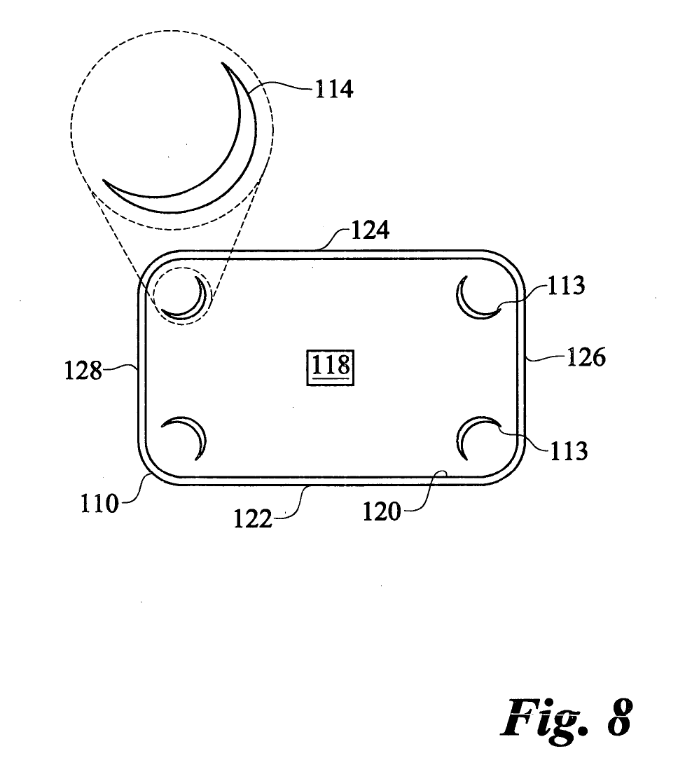

In another embodiment of the present invention, as seen in FIGS. 7 and 8, the layer securing fixtures (112) are posts (113) having a layer securing fixture height (116) and a cross section (114). The posts (113) are attached to the granule contact surface (118) within the base perimeter (120) and extend substantially perpendicular to the granule contact surface (118). The securing fixture height (116) may be long enough to extend out of the litter granules (10). The posts (113) may be solid or hollow. In one embodiment of the present invention, the post cross section (114) has a half-moon shape, best seen in FIGS. 1 and 8. The half-moon shaped posts (113) are positioned to allow the sieve (140) and liner (170) to pass easily between the wall (121) and the posts (113) yet substantially block the litter granules (10) from entering into the area between the concave portion of the half-moon shaped post (113) and the wall (121). In another embodiment of the instant invention, the posts (113) may be “C” shaped. The “C” may be a hollow tube with a longitudinal portion removed to permit insertion of a human finger. During the cleaning process, the owner may reach under the first liner (170) or sieve (140) and insert one of their fingers into an open region of the post (113). In this embodiment then, the first sieve securing receptacle (142) or first liner securing receptacle (242) may be more easily released from, and guided off, the layer securing receptacle (112).

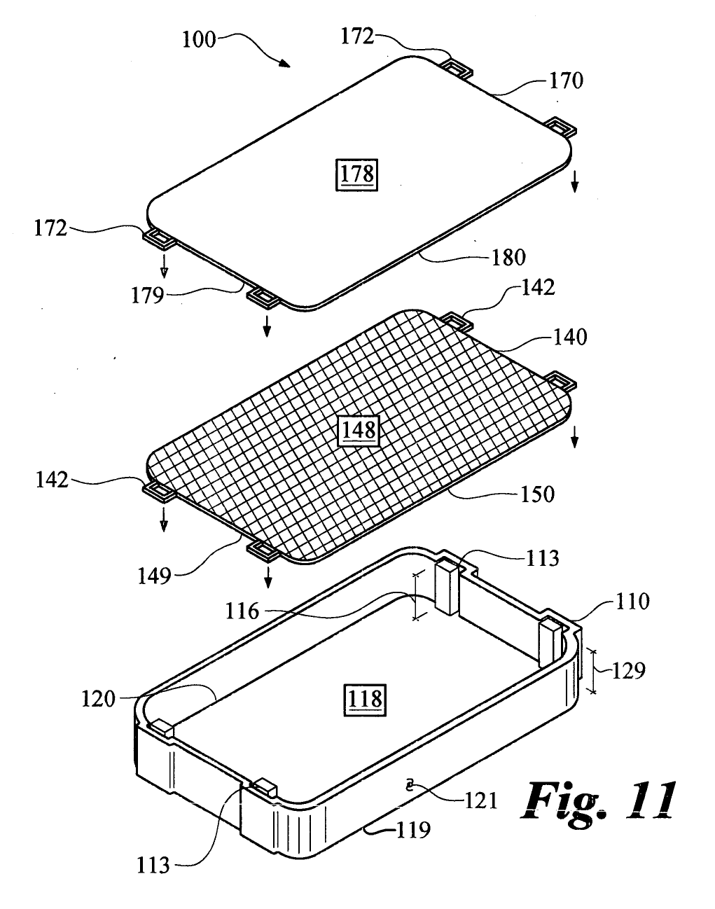

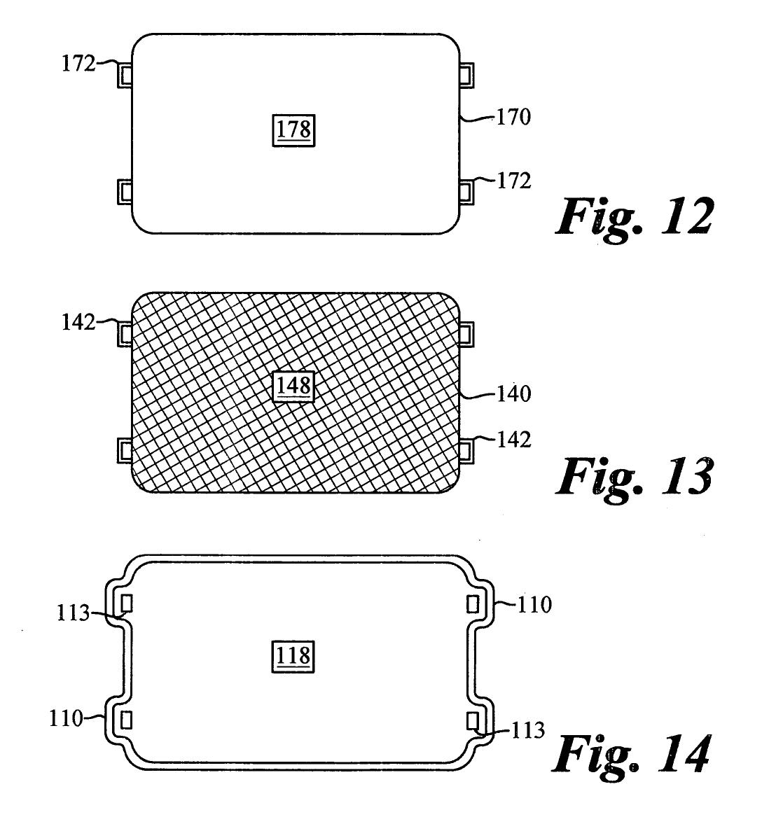

In another embodiment of the instant invention, seen in FIGS. 11, 12, 13, and 14, the posts (113) have a cross section (114) with a rectangular shape and the wall (121) has recesses to accommodate passage of the sieve securing and liner securing receptacles (142, 172) having a rectangular shape between the wall and the post (113). The placement of the posts (113) substantially prevents litter granules (10) from entering into the recess area between the post (113) and the wall (121) thereby making removal of the sieve (140) and the liner (170) easy.

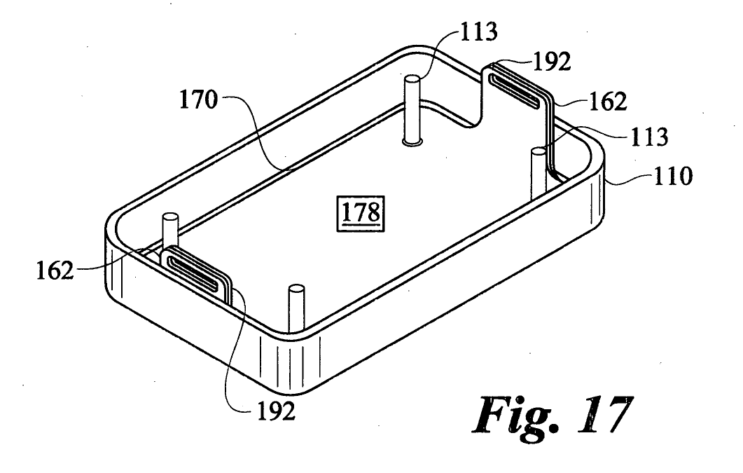

In another embodiment of the present invention, seen in FIG. 17, the post cross section (114) may be substantially round. In other words, the posts (113) may be substantially cylindrical. However, one skilled in the art will observe and appreciate that the post cross section (114) may be other shapes and that the post cross section (114) need not be uniform along the height of the post (113) but may vary by height above the granule contact surface (118) to accomplish releasable attachment to the first sieve and first liner securing receptacles (142, 172).

In another embodiment of the present invention, with reference again to FIGS. 7 and 8, the base perimeter (120) is substantially rectangular and the wall (121) has a proximal side (122), a distal side (124), a dextral side (126), and a sinistral side (128). The base (110) has four layer securing fixtures (112) positioned near each corner of the base perimeter (120). However, as previously mentioned, it is not necessary to have the layer securing fixtures (112) located near each corner. For example, the layer securing fixtures (112) could be located near the midpoint of at least two of the sides (122, 124, 126, 128), or virtually anywhere within the base perimeter (120). Generally, with reference to FIGS. 7 and 8, as one skill in the art will observe and appreciate, in the embodiment with the rectangular base, the first sieve perimeter (150) has four edges, namely: a first sieve proximal edge (152), a first sieve distal edge (154), a first sieve dextral edge (156), and a first sieve sinistral edge (158). In addition, the first sieve (140) has four first sieve securing receptacles (142) that releasably cooperate with the layer securing fixtures (112). Similarly, the first liner perimeter (180) has four edges, namely: a first liner proximal edge (182), a first liner distal edge (184), a first liner dextral edge (186), and a first liner sinistral edge (188). In addition, the first liner (170) has four first liner securing receptacles (172) that releasably cooperate with the layer securing fixtures (112).

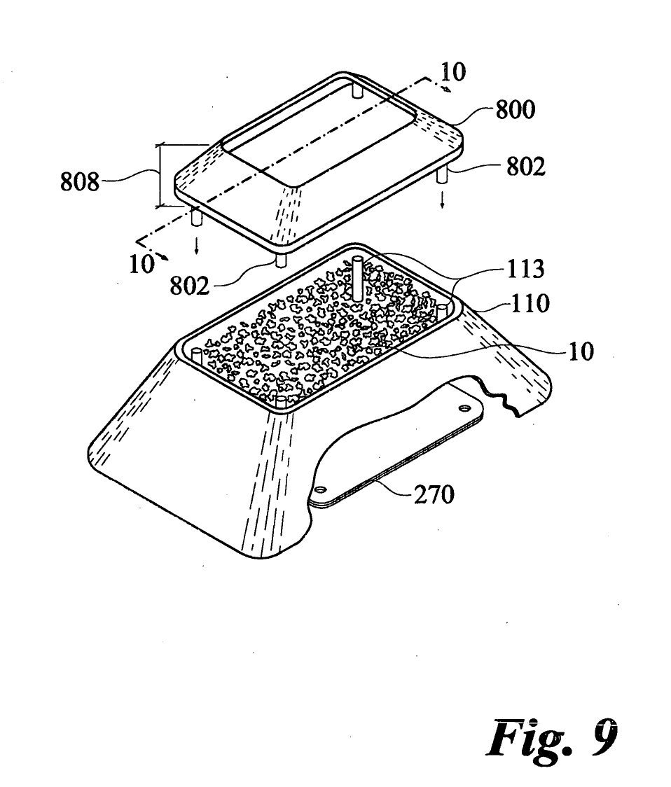

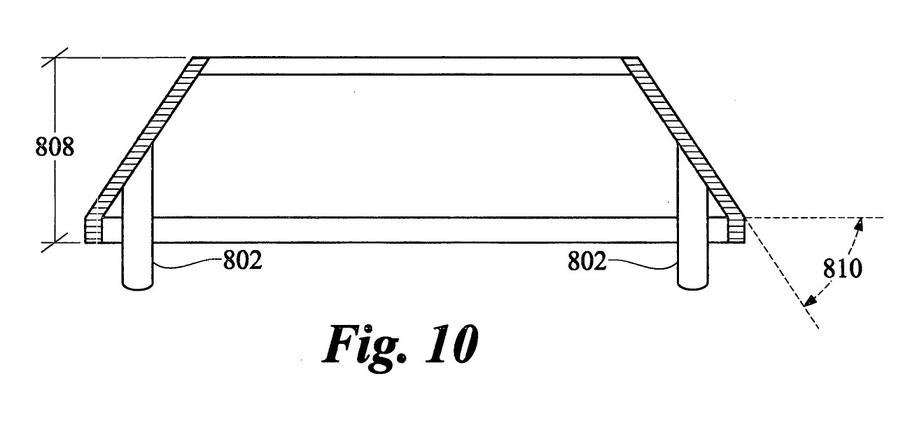

In another embodiment of the instant invention, the cat litter box cleaning system (100) includes a protective rim (800). As seen in FIG. 9, if the cat decides to dig into the litter, the protective rim (800) helps keep the litter granules (10) confined within the base (110). The protective rim (800) has at least two rim securing receptacles (802), a rim height (808) and a rim angle (810). The position of the rim securing receptacles (802) positions the protective rim (800) over the litter. The protective rim (800) extends from the top of the wall (121) toward the middle of the base (110) at the rim angle (810), as seen in FIG. 10, so that the protective rim (800) slants away from the granule contact surface (118) or in an upward direction. The rim angle (810) is measured between a line coincident in the protective rim (800) and a plane parallel with the granule contact surface (118). As one skilled in the art will appreciate, the rim angle (810) may be varied to improve the efficiency of the protective rim (800) in knocking down litter granules (10) that become airborne while the cat is using the cat litter box cleaning system (100).

In one embodiment, as seen in FIG. 9, the number of the rim securing receptacles (802) equals the number the layer securing fixtures (112). The rim securing receptacles (802) releasably cooperate with the layer securing fixtures (112). In addition to helping keep the surrounding area free of spilled litter granules (10), once in position, the protective rim (800) may also keep the first sieve (140) and the first liner (170) confined within the base (110) by capping the layer securing fixture (112). In one embodiment of the instant invention, the rim height (808) is between approximately three and approximately six inches and the rim angle (810) is between approximately zero and approximately eighty-nine degrees with respect to the granule contact surface (118).

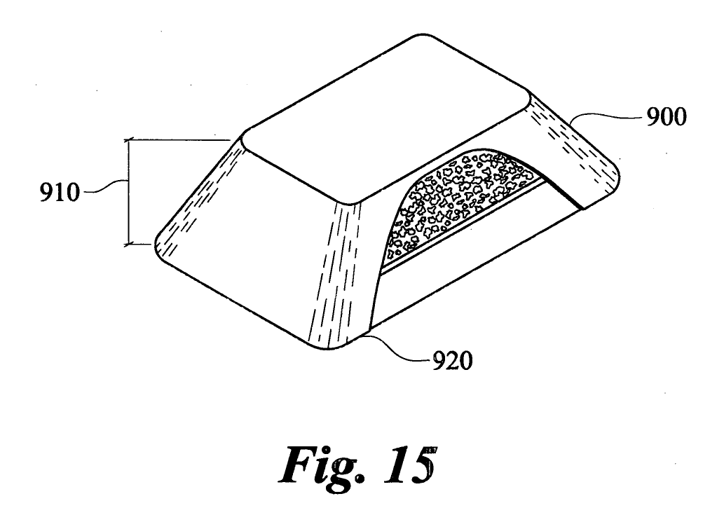

In another embodiment of the present invention, as seen in FIG. 15, the cat litter box cleaning system (100) includes a storage cover (900). The storage cover (900) is designed to at least keep the litter granules (10), and any waste clumps (20), hidden from view. If the cat litter box cleaning system (100) is located in an area where it might be easily seen when the owner has guests in their home, the owner may feel that it is necessary to cover the waste clumps (20) to hide their unsightly appearance or retard the escape of any pungent odor. Rather than move the system (100) to another out-of-the-way location, the owner can put on the storage cover (900). The storage cover (900) has a storage cover height (910) and a storage cover support edge (920). In one embodiment of the instant invention, the storage cover (900) may completely enclose the base (110). In this embodiment, the storage cover height (910) may be greater than the layer securing fixture height (116) plus the rim height (808) plus room for the cat, and the storage cover support edge (920) fits around, or encircles, the base (110); however, the storage cover (900) may have an opening which the cat may use to enter and leave the base (110). The storage cover (900) may have any shape, may include a handle, and may be made from many different materials. In one embodiment of the instant invention, the storage cover (900) is placed over the base (110) and remains in position solely by gravity. The storage cover (900) may contact other portions of the cat litter box cleaning system (100), but contact is not necessary. In another embodiment of the instant invention, the storage cover (900) releasably contacts the protective rim (800) or the wall (121) preventing visibility of the litter granules (10) and the waste clumps (20).

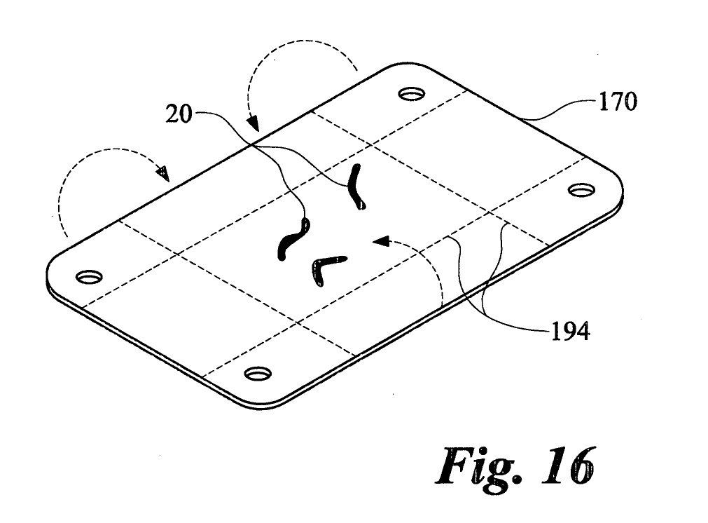

As seen in FIG. 16, in yet another embodiment of the present invention, the first liner (170) is disposable and has a plurality of first fold lines (194). The first liner (170) may be crushed or folded to prevent any cat waste from contacting and contaminating other surfaces. The fold lines (194) may provide a predicable, repeatable method of folding for hygienically disposing of the soiled liner (170) and the waste clumps (20). By folding the first liner (170) along the fold lines (194) the owner may prevent feces or urine from contacting their clothes, hands, or other surrounding surface. In addition, after removing the waste clumps (20) from the litter granules (10) with one of the sieves (140), the captured waste clumps (20) and the soiled first sieve (140) may be placed onto the first liner (170) so that all of the soiled materials and the waste clumps (20) are disposed of easily and cleanly. The fold lines (194) may include one or more die cuts, perforations, indentations, score lines, and weakened fold lines to ease folding the first liner (170) for disposal.

Referring now to FIG. 7, in yet another embodiment of the instant invention for making the removal of the first layer easy and convenient, the first sieve (140) has a first sieve gripping extension (160) and the first liner (170) has a first liner gripping extension (190). The sieve gripping and liner gripping extensions (160, 190) are attached to the sieve and liner perimeters (150, 180). When the first sieve (140) and first liner (170) are installed, the sieve gripping and liner gripping extensions (160, 190) extend upwards along the wall (121) out of the litter granules (10) on opposing sides of the base (110). The gripping extensions (160, 190) may be an extension of the first liner (170) or first sieve (140) material or the gripping extensions (160, 190) may be wire, fibers, or other materials attached to the first sieve (140) or first liner (170). The gripping extensions (160, 190) may extend from multiple directions and may be coded or identified by color, number, or lettering to differentiate between the first sieve (140) and the liner (170) when the first layer is hidden from view beneath the litter granules (10). As seen in FIG. 17, in another embodiment of the instant invention the first sieve gripping extensions (160) are sieve gripping extension tabs (162), and the first liner gripping extensions (190) are liner gripping extension tabs (192). To further ease sieve (140) and liner (170) removal, the first liner and first sieve gripping extension tabs (162, 192) may extend from two opposing sides of the first sieve and first liner (140, 170).

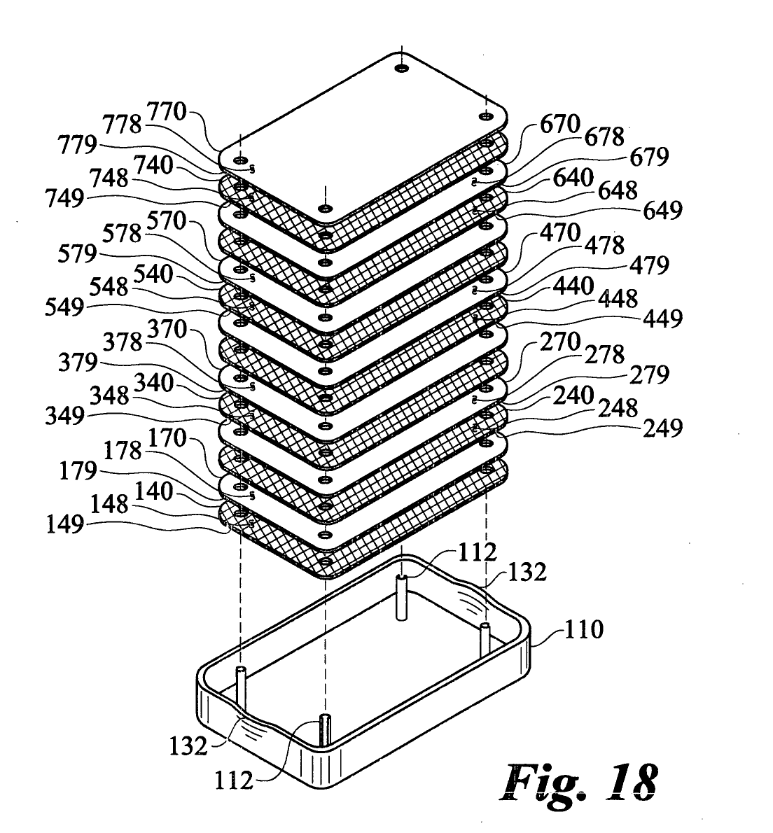

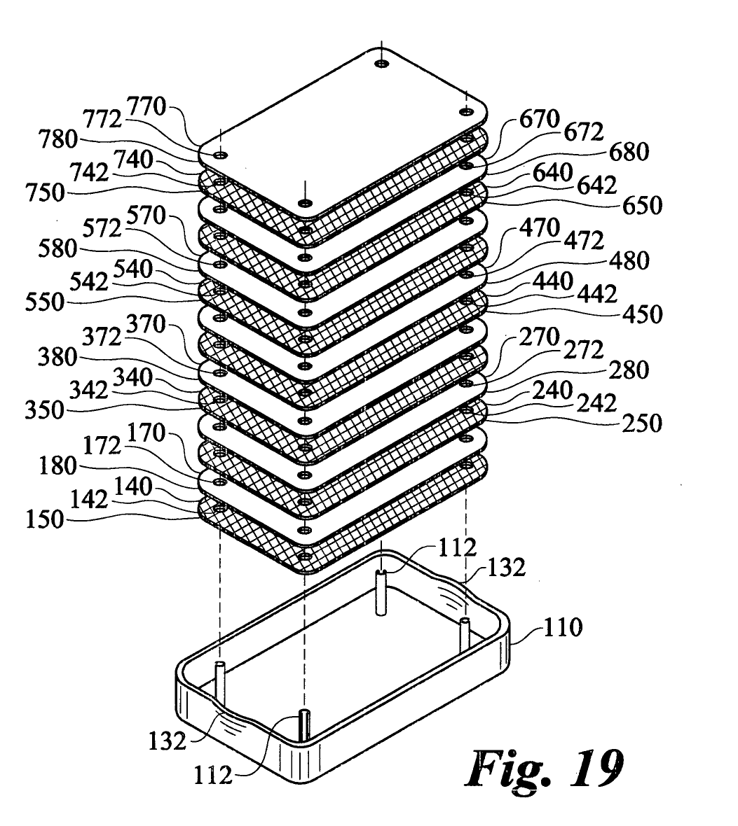

In another embodiment of the present invention, as seen in FIGS. 18 and 19, the cat litter box cleaning system (100) includes multiple layers. That is, a second layer, a third layer, a fourth layer, a fifth layer, a sixth layer, and a seventh layer, in addition to the first layer, collectively referred to the “layers.” As one skilled in the art will recognize, the second, third, fourth, fifth, sixth, and seventh layers may be substantially similar to the first layer, described above. Now, each of the layers will be described in complete detail.

With reference generally to FIGS. 18 and 19, the second layer has a second sieve (240) and a second liner (270). The second sieve (240) has at least two second sieve securing receptacles (242). The second sieve (240) also has a second sieving surface (248), a second sieve bottom surface (249), and a second sieve perimeter (250). The second sieve perimeter (250) is substantially the same as the base perimeter (120). When the second sieve (240) is positioned within the base (110), the second sieve bottom surface (249) is adjacent to the first liner granule contact surface (178). The second sieve securing receptacles (242) releasably cooperate with layer securing fixtures (112).

With continued reference to FIGS. 18 and 19, the second liner (270) has at least two second liner securing receptacles (272). The second liner securing receptacles (272) releasably cooperate with the layer securing fixtures (112). The second liner (270) has a second granule contact surface (278), a second liner bottom surface (279), and a second liner perimeter (280). The second liner perimeter (280) is substantially the same as the base perimeter (120). When the second liner (270) is positioned within the base (110), the second liner bottom surface (279) is adjacent to the second sieving surface (248).

The third layer has a third sieve (340) and a third liner (370), as seen in FIGS. 18 and 19. The third sieve (340) has at least two third sieve securing receptacles (342). The third sieve securing receptacles (342) releasably cooperate with the layer securing fixtures (112). The third sieve (340) has a third sieving surface (348), a third sieve bottom surface (349), and a third sieve perimeter (350). The third sieve perimeter (350) is substantially the same as the base perimeter (120). When the third sieve (370) is positioned within the base (110), the third sieve bottom surface (349) is adjacent to the second liner granule contact surface (278).

With continued reference to FIGS. 18 and 19, the third liner (370) has at least two third liner securing receptacles (372). The third liner securing receptacles releasably cooperate with the layer securing fixtures (112). The third liner (370) has a third granule contact surface (378), a third liner bottom surface (379), and a third liner perimeter (380). The third liner perimeter (380) is substantially the same as the base perimeter (120). When the third liner (370) is positioned within the base (110), the third liner bottom surface (379) is adjacent to the third sieving surface (348).

The fourth layer has a fourth sieve (440) and a fourth liner (470), as seen in FIGS. 18 and 19. The fourth sieve (440) has at least two fourth sieve securing receptacles (442). The fourth sieve securing receptacles (442) releasably cooperate with the layer securing fixtures (112). The fourth sieve (440) has a fourth sieving surface (448), a fourth sieve bottom surface (449), and a fourth sieve perimeter (450). The fourth sieve perimeter (450) is substantially the same as the base perimeter (120). When the fourth sieve (470) is positioned within the base (110), the fourth sieve bottom surface (449) is adjacent to the third liner granule contact surface (378).

With continued reference to FIGS. 18 and 19, the fourth liner (470) has at least two fourth liner securing receptacles (472). The fourth liner securing receptacles releasably cooperate with the layer securing fixtures (112). The fourth liner (470) has a fourth granule contact surface (478), a fourth liner bottom surface (479), and a fourth liner perimeter (480). The fourth liner perimeter (480) is substantially the same as the base perimeter (120). When the fourth liner (470) is positioned within the base (110), the fourth liner bottom surface (479) is adjacent to the fourth sieving surface (448).

The fifth layer has a fifth sieve (540) and a fifth liner (570), as seen in FIGS. 18 and 19. The fifth sieve (540) has at least two fifth sieve securing receptacles (542). The fifth sieve securing receptacles (542) releasably cooperate with the layer securing fixtures (112). The fifth sieve (540) has a fifth sieving surface (548), a fifth sieve bottom surface (549), and a fifth sieve perimeter (550). The fifth sieve perimeter (550) is substantially the same as the base perimeter (120). When the fifth sieve (570) is positioned within the base (110), the fifth sieve bottom surface (549) is adjacent to the fourth liner granule contact surface (478).

With continued reference to FIGS. 18 and 19, the fifth liner (570) has at least two fifth liner securing receptacles (572). The fifth liner securing receptacles (542) releasably cooperate with the layer securing fixtures (I 12). The fifth liner (570) has a fifth granule contact surface (578), a fifth liner bottom surface (579), and a fifth liner perimeter (580). The fifth liner perimeter (580) is substantially the same as the base perimeter (120). When the fifth liner (570) is positioned within the base (110), the fifth liner bottom surface (579) is adjacent to the fifth sieving surface (448).

The sixth layer has a sixth sieve (640) and a sixth liner (670), as seen in FIGS. 18 and 19. The sixth sieve (640) has at least two sixth sieve securing receptacles (642). The sixth sieve securing receptacles (642) releasably cooperate with the layer securing fixtures (112). The sixth sieve (640) has a sixth sieving surface (648), a sixth sieve bottom surface (649), and a sixth sieve perimeter (650). The sixth sieve perimeter (650) is substantially the same as the base perimeter (120). When the sixth sieve (670) is positioned within the base (110), the sixth sieve bottom surface (649) is adjacent to the fifth liner granule contact surface (578).

With continued reference to FIGS. 18 and 19, the sixth liner (670) has at least two sixth liner securing receptacles (672). The sixth liner securing receptacles (642) releasably cooperate with the layer securing fixtures (112). The sixth liner (670) has a sixth granule contact surface (678), a sixth liner bottom surface (679), and a sixth liner perimeter (680). The sixth liner perimeter (680) is substantially the same as the base perimeter (120). When the sixth liner (670) is positioned within the base (110), the sixth liner bottom surface (679) is adjacent to the sixth sieving surface (648).

The seventh layer has a seventh sieve (640) and a seventh liner (670), as seen in FIGS. 18 and 19. The seventh sieve (740) has at least two seventh sieve securing receptacles (742). The seventh sieve securing receptacles (742) releasably cooperate with the layer securing fixtures (112). The seventh sieve (740) has a seventh sieving surface (748), a seventh sieve bottom surface (749), and a seventh sieve perimeter (750). The seventh sieve perimeter (750) is substantially the same as the base perimeter (120). When the seventh sieve (770) is positioned within the base (110), the seventh sieve bottom surface (749) is adjacent to the sixth liner granule contact surface (678).

With continued reference to FIGS. 18 and 19, the seventh liner (770) has at least two seventh liner securing receptacles (772). The seventh liner securing receptacles (742) releasably cooperate with the layer securing fixtures (112). The seventh liner (770) has a seventh granule contact surface (778), a seventh liner bottom surface (779), and a seventh liner perimeter (780). The seventh liner perimeter (780) is substantially the same as the base perimeter (120). When the seventh liner (770) is positioned within the base (110), the seventh liner bottom surface (779) is adjacent to the seventh sieving surface (748). Furthermore, as seen in FIGS. 18 and 19, each of the layers has a liner (170, 270, 370, 470, 570, 670, 770), referred to collectively as the “liners” and individually as “liner” and a sieve (140, 240, 340, 440, 540, 640, 740), hereinafter referred to collectively as the “sieves” and individually as the “sieve.”

With continued reference to FIGS. 18 and 19, by placing the litter granules (20) on the seventh layer, multiple cleaning operations may be conveniently performed before having to remove the litter granules (10) from the base (110). The owner may periodically clean the litter granules (20) of waste clumps (10) up to seven times, one time for each of the layers. Each cleaning operation consists of removing the liner immediately beneath the litter granules (10) and the waste clumps (20), dumping the litter granules (10) and the waste clumps (20) onto the exposed sieve, withdrawing the sieve and directing the litter granules (10) that pass through the sieve onto the next exposed liner, and disposing of the sieve with any residual waste clumps (20). The process may be repeated at a frequency dictated by the needs of the cat and the preferences of the owner.

In yet another embodiment of the instant invention, the wall (121) is formed with gripping alcoves (132), as seen in FIGS. 9, 18, and 19. In one embodiment, the gripping alcoves (132) provide space between the wall (121) and the layers. In another embodiment, the gripping alcoves (132) provide space between the wall (121) and the layer securing fixtures (112). When the owner desires to clean the waste clumps (20) from the litter granules (10), the owner may easily place their hand into the space created by the gripping alcove (132) to grasp the liner or the sieve in question.

In another embodiment of the present invention, as seen in FIG. 9, the base (110) is formed with a liner storage compartment (130). The liners may be reusable, rather than disposable as previously discussed. The reusable liners may be conveniently stored within the liner storage compartment (130). As one skilled in the art will appreciate, after the waste clumps (20) are removed from the litter granules (10), reusable liners may be conveniently stored until the last layer is used to clean the litter granules (10). In one embodiment, as seen in FIG. 9, the liner storage compartment (130) is a void space within the base (110). The reusable liners are stacked one on another, and the base (110) is positioned over the stacked liners. As one skilled in the art will appreciate, other storage compartment arrangements are possible. By way of example only, and not limitation, the liners may be placed into individual slots. Alternatively, a single wide slot may be utilized to store the liners with the same convenience. In another embodiment of the instant invention, the reusable liners have perimeters (180, 280, 380, 480, 580, 680, 780) which are curled in an upward manner to facilitate orderly stacking of the liners.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

I claim:

1. A cat litter box cleaning system (100) for hygienically removing waste clumps (20) from a plurality of litter granules (10), comprising:
a base (110) having a granule contact surface (118), a base perimeter (120), and at least two layer securing fixtures (112), wherein the base perimeter (120) has a wall (121) extending substantially perpendicular from the granule contact surface (118) to a wall height (129), and the layer securing fixtures (112) are attached to the granule contact surface (118) and are located within the base perimeter (120);
a first layer having a first sieve (140) and a first liner (170), wherein
(A) the first sieve (140) has at least as many first sieve securing receptacles (142) as layer securing fixtures (112), a first sieving surface (148), a first sieve bottom surface (149), and a first sieve perimeter (150), wherein the first sieve perimeter (150) is substantially the same as the base perimeter (120), the first sieve bottom surface (149) is adjacent to the base granule contact surface (118), and the first sieve securing receptacles (142) releasably cooperate with the securing fixtures (112); and
(B) the first liner (170) has at least as many first liner securing receptacles (172) as layer securing fixtures (112), a first liner granule contact surface (178), a first liner bottom surface (179), and a first liner perimeter (180), wherein the first liner perimeter (180) is substantially the same as the base perimeter (120), the first liner bottom surface (179) is adjacent to the first sieving surface (148), and the first liner securing receptacles (172) releasably cooperate with the layer securing fixtures (112), wherein the waste clumps (20) are separated from the litter granules (10) by
(i) releasing the first liner securing receptacles (172) from the layer securing fixtures (112),
(ii) removing the first liner (170) from the base (110),
(iii) dumping the waste clumps (20) and the litter granules (10) onto the first sieving surface (148) of the first sieve (140),
(iv) releasing the first sieve securing receptacles (142) from the layer securing fixtures (112), and
(v) removing the first sieve (140) so that the litter granules (10) pass through the first sieve (140) and into the base (110) while the waste clumps (20) are retained on the first sieving surface (148).

2. The cat litter box cleaning system (100) of claim 1, wherein the layer securing fixtures (112) are posts (113) having a layer securing fixture height (116) and a post cross section (114), and wherein the posts (113) extend substantially perpendicular to the granule contact surface (118).

3. The cat litter box cleaning system (100) of claim 2, wherein the post cross section (114) has a half-moon shape that cooperates with a human fingertip.

4. The cat litter box cleaning system (100) of claim 2, wherein the post cross section (114) has a rectangular shape.

5. The cat litter box cleaning system (100) of claim 1, wherein the wall (121) is formed with two gripping alcoves (132) each of which cooperate with a human hand.

6. The cat litter box cleaning system (100) of claim 1, wherein the first sieve (140) further includes a first sieve gripping extension (160) and the first liner (170) further includes a first liner gripping extension (190), wherein the first sieve gripping extension (160) and the first liner gripping extension (190) extend up the wall (121) through the litter granules (10) thereby providing gripping access above the litter granules (10) for removing the first sieve (140) and first liner (170).

7. The cat litter box cleaning system (100) of claim 6, wherein the first sieve gripping extension (160) is a first sieve gripping extension tab (162) and the first liner gripping extension (190) is a first liner gripping extension tab (192).

8. The cat litter box cleaning system (100) of claim 1, wherein the base perimeter (120) is substantially rectangular and the wall (121) has a proximal side (122), a distal side (124), a dextral side (126), and a sinistral side (128) and the wall height (129) is between approximately three and approximately twelve inches, the base (110) has four layer securing fixtures (112) positioned within the base perimeter (120), the first sieve (140) has at least four first sieve securing receptacles (142) that releasably cooperate with the layer securing fixtures (112), and the first liner (170) has at least four first liner securing receptacles (172) that releasably cooperate with the layer securing fixtures (112).

9. The cat litter box cleaning system (100) of claim 1, wherein the base (110) is formed with a liner storage compartment (130) to releasably house the liners (170).

10. The cat litter box cleaning system (100) of claim 1, further including a protective rim (800) having at least two rim securing receptacles (802), a rim height (808), and a rim angle (810), wherein the protective rim (800) extends from the wall (121) toward the middle of the base (110) away from the granule contact surface (118) at the rim angle (810), as measured between an intersection of a line coincident with the protective rim and a plane parallel with the granule contact surface (118), the rim securing receptacles (802) releasably cooperate with the layer securing fixtures (112), and the rim height (808) measures between approximately one-half inch and approximately six inches.

11. The cat litter box cleaning system (100) of claim 1, further including a storage cover (900) having a storage cover height (910) and a storage cover support edge (920) wherein the storage cover height (910) is greater than the layer securing fixture height (116) and the storage cover support edge (920) encircles the base (110) when the storage cover (900) is positioned over the base (110).

12. The cat litter box cleaning system of claim 1, wherein the first liner (170) has a plurality of first fold lines (194), wherein the first fold lines (194) comprises one or more of the group consisting of die cuts, perforations, indentations, score lines, and weakened fracture lines.

13. The cat litter box cleaning system (100) of claim 1, further including a second layer, a third layer, a fourth layer, a fifth layer, a sixth layer, and a seventh layer, wherein
(A) the second layer has a second sieve (240) and a second liner (270), wherein
(i) the second sieve (240) has at least as many second sieve securing receptacles (242) as layer securing fixtures (112), a second sieving surface (248), a second sieve bottom surface (249), and a second sieve perimeter (250), wherein the second sieve perimeter (250) is substantially the same as the base perimeter (120) and the second sieve bottom surface (249) is adjacent to the first liner granule contact surface (178), and the second sieve securing receptacles (242) releasably cooperate with the layer securing fixtures (112), and
(ii) the second liner (270) has at least as many second liner securing receptacles (272) as layer securing fixtures (112), a second granule contact surface (278), a second liner bottom surface (279), and a second liner perimeter (280), wherein the second liner perimeter (280) is substantially the same as the base perimeter (120) and the second liner bottom surface (279) is adjacent to the second sieving surface (248), and the second liner securing receptacles (272) releasably cooperate with the layer securing fixtures (112);
(B) the third layer has a third sieve (340) and a third liner (370), wherein
(i) the third sieve (340) has at least as many third sieve securing receptacles (342) as layer securing fixtures (112), a third sieving surface (348), a third sieve bottom surface (349), and a third sieve perimeter (350), wherein the third sieve perimeter (350) is substantially the same as the base perimeter (120) and the third sieve bottom surface (349) is adjacent to the second liner granule contact surface (278), and the third sieve securing receptacles (342) releasably cooperate with the layer securing fixtures (112), and
(ii) the third liner (370) has at least as many third liner securing receptacles (372) as layer securing fixtures (112), a third granule contact surface (378), a third liner bottom surface (379), and a third liner perimeter (380), wherein the third liner perimeter (380) is substantially the same as the base perimeter (120) and the third liner bottom surface (379) is adjacent to the third sieving surface (348), and the third liner securing receptacles (372) releasably cooperate with the layer securing fixtures (112);
(C) the fourth layer has a fourth sieve (440) and a fourth liner (470), wherein
(i) the fourth sieve (440) has at least as many fourth sieve securing receptacles (442) as layer securing fixtures (112), a fourth sieving surface (448), a fourth sieve bottom surface (449), and a fourth sieve perimeter (450), wherein the fourth sieve perimeter (450) is substantially the same as the base perimeter (120) and the fourth sieve bottom surface (449) is adjacent to the third liner granule contact surface (378), and the fourth sieve securing receptacles (442) releasably cooperate with the layer securing fixtures (112), and
(ii) the fourth liner (470) has at least as many fourth liner securing receptacles (472) as layer securing fixtures (112), a fourth granule contact surface (478), a fourth liner bottom surface (479), and a fourth liner perimeter (480), wherein the fourth liner perimeter (480) is substantially the same as the base perimeter (120) and the fourth liner bottom surface (479) is adjacent to the fourth sieving surface (448), and the fourth liner securing receptacles (472) releasably cooperate with the layer securing fixtures (112);
(D) the fifth layer has a fifth sieve (540) and a fifth liner (570), wherein
(i) the fifth sieve (540) has at least as many fifth sieve securing receptacles (542) as layer securing fixtures (112), a fifth sieving surface (548), a fifth sieve bottom surface (549), and a fifth sieve perimeter (550), wherein the fifth sieve perimeter (550) is substantially the same as the base perimeter (120) and the fifth sieve bottom surface (549) is adjacent to the fourth liner granule contact surface (478), and the fifth sieve securing receptacles (542) releasably cooperate with the layer securing fixtures (112), and
(ii) the fifth liner (570) has at least as many fifth liner securing receptacles (572) as layer securing fixtures (112), a fifth granule contact surface (578), a fifth liner bottom surface (579), and a fifth liner perimeter (580), wherein the fifth liner perimeter (580) is substantially the same as the base perimeter (120) and the fifth liner bottom surface (579) is adjacent to the fifth sieving surface (548), and the fifth liner securing receptacles (572) releasably cooperate with the layer securing fixtures (112);
(E) the sixth layer has a sixth sieve (640) and a sixth liner (670), wherein
(i) the sixth sieve (640) has at least as many sixth sieve securing receptacles (642) as layer securing fixtures (112), a sixth sieving surface (648), a sixth sieve bottom surface (649), and a sixth sieve perimeter (650), wherein the sixth sieve perimeter (650) is substantially the same as the base perimeter (120) and the sixth sieve bottom surface (649) is adjacent to the fifth liner granule contact surface (578), and the sixth sieve securing receptacles (642) releasably cooperate with the layer securing fixtures (112), and
(ii) the sixth liner (670) has at least as many sixth liner securing receptacles (672) as layer securing fixtures (112), a sixth granule contact surface (678), a sixth liner bottom surface (679), and a sixth liner perimeter (680), wherein the sixth liner perimeter (680) is substantially the same as the base perimeter (120) and the sixth liner bottom surface (679) is adjacent to the sixth sieving surface (648), and the sixth liner securing receptacles (672) releasably cooperate with the layer securing fixtures (112); and
(F) the seventh layer has a seventh sieve (740) and a seventh liner (770), wherein
(i) the seventh sieve (740) has at least as many seventh sieve securing receptacles (742) as layer securing fixtures (112), a seventh sieving surface (748), a seventh sieve bottom surface (749), and a seventh sieve perimeter (750), wherein the seventh sieve perimeter (750) is substantially the same as the base perimeter (120) and the seventh sieve bottom surface (749) is adjacent to the sixth liner granule contact surface (678), and the seventh sieve securing receptacles (742) releasably cooperate with the layer securing fixtures (112), and
(ii) the seventh liner (770) has at least as many seventh liner securing receptacles (772) as layer securing fixtures (112), a seventh granule contact surface (778), a seventh liner bottom surface (779), and a seventh liner perimeter (780), wherein the seventh liner perimeter (780) is substantially the same as the base perimeter (120) and the seventh liner bottom surface (779) is adjacent to the seventh sieving surface (748), and the seventh liner securing receptacles (772) releasably cooperate with the layer securing fixtures (112).

14. A cat litter box cleaning system (100) for hygienically removing waste clumps (20) from a plurality of litter granules (10), comprising:
a base (110) having a granule contact surface (118), a base perimeter (120), and at least two layer securing fixtures (112), wherein the base perimeter (120) has a wall (121) extending at a substantially perpendicular angle to the granule contact surface (118) to a wall height (129) and the layer securing fixtures (112) are posts (113) having a securing fixture height (116) and a cross section (114) and wherein the posts (113) are located within the base perimeter (120), the post cross section (114) has a rectangular shape, and wherein the base perimeter (120) is substantially rectangular and the wall (121) has a proximal side (122), a distal side (124), a dextral side (126), and a sinistral side (128) and the wall height (129) is between approximately three and twelve inches;
a first layer having a first sieve (140) and a first liner (170), wherein
(A) the first sieve (140) has at least as many first sieve securing receptacles (142) as posts (113), a first sieving surface (148), a first sieve bottom surface (149), and a first sieve perimeter (150), wherein the first sieve perimeter (150) is substantially the same as the base perimeter (120), the first sieve bottom surface (149) is adjacent to the base granule contact surface (118), and the first sieve securing receptacles (142) releasably cooperate with the posts (113); and
(B) the first liner (170) has at least as many first liner securing receptacles (172) as posts (113), a first liner granule contact surface (178), a first liner bottom surface (179), and a first liner perimeter (180), wherein the first liner perimeter (180) is substantially the same as the base perimeter (120), the first liner bottom surface (179) is adjacent to the first sieving surface (148), and the first liner securing receptacles (172) releasably cooperate with the posts (112); and
a protective rim (800) having at least two rim securing receptacles (802), a rim height (808), and a rim angle (810), wherein the protective rim (800) extends from the wall (121) toward the middle of the base (110) away from the granule contact surface (118) at the rim angle (810), as measured between an intersection of a line coincident with the protective rim and a plane parallel with the granule contact surface (118), the rim securing receptacles (802) releasably cooperate with the posts (113), and the rim height (808) measures between approximately one-half inch and approximately six inches, wherein the waste clumps (20) are separated from the litter granules (10) by
(i) releasing the rim securing receptacles (802) from the layer securing fixtures (112),
(ii) removing the protective rim (800) from the layer securing fixtures (112),
(iii) releasing the first liner securing receptacles (172) from the layer securing fixtures (112),
(iv) removing the first liner (170) from the base (110),
(v) dumping the waste clumps (20) and the litter granules (10) onto the first sieving surface (148) of the first sieve (140),
(vi) releasing the first sieve securing receptacles (142) from the layer securing fixtures (112), and
(vii) removing the first sieve (140) so that the litter granules (10) pass through the first sieve (140) and into the base (110) while the waste clumps (20) are retained on the first sieving surface (148).
a storage cover (900) having a storage cover height (910) and a storage cover support edge (920) wherein the storage cover height (910) is greater than the layer securing fixture height (116) plus the rim height (808) and the storage cover support edge (920) encircles the base (110) when the storage cover (900) is positioned over the base (110), thereby the storage cover (900) substantially prevents access to the litter granules (10) when in position.

15. The cat litter box cleaning system (100) of claim 14, wherein the base (110) has a liner storage compartment (130) to releasably house the liners (170).

16. The cat litter box cleaning system of claim 14, wherein the first liner (170) has a plurality of first fold lines (194), wherein the first fold lines (194) comprises one or more of the group consisting of die cuts, perforations, indentations, score lines, and weakened fracture lines.

17. The cat litter box cleaning system (100) of claim 14, wherein the wall (121) is formed with a gripping alcove (132) that cooperates with a human hand.

18. The cat litter box cleaning system (100) of claim 14, wherein the first sieve (140) further includes a first sieve gripping extension (160) and the first liner (170) further includes a first liner gripping extension (190).

19. The cat litter box cleaning system (100) of claim 18, wherein the first sieve gripping extension (160) is a first sieve gripping extension tab (162) and the first liner gripping extension (190) is a first liner gripping extension tab (192).

20. The cat litter box cleaning system (100) of claim 14, further including a second layer, a third layer, a fourth layer, a fifth layer, a sixth layer, and a seventh layer, wherein
(A) the second layer has a second sieve (240) and a second liner (270), wherein
(i) the second sieve (240) has at least as many second sieve securing receptacles (242) as posts (113), a second sieving surface (248), a second sieve bottom surface (249), and a second sieve perimeter (250), wherein the second sieve perimeter (250) is substantially the same as the base perimeter (120) and the second sieve bottom surface (249) is adjacent to the first liner granule contact surface (178), and the second sieve securing receptacles (242) releasably cooperate with the posts (113), and
(ii) the second liner (270) has at least as many second liner securing receptacles (272) as posts (113), a second granule contact surface (278), a second liner bottom surface (279), and a second liner perimeter (280), wherein the second liner perimeter (280) is substantially the same as the base perimeter (120) and the second liner bottom surface (279) is adjacent to the second sieving surface (248), and the second liner securing receptacles (272) releasably cooperate with the posts (113);
(B) the third layer has a third sieve (340) and a third liner (370), wherein
(i) the third sieve (340) has at least as many third sieve securing receptacles (342) as posts (113), a third sieving surface (348), a third sieve bottom surface (349), and a third sieve perimeter (350), wherein the third sieve perimeter (350) is substantially the same as the base perimeter (120) and the third sieve bottom surface (349) is adjacent to the second liner granule contact surface (278), and the third sieve securing receptacles (342) releasably cooperate with the posts (113), and
(ii) the third liner (370) has at least as many third liner securing receptacles (372) as posts (113), a third granule contact surface (378), a third liner bottom surface (379), and a third liner perimeter (380), wherein the third liner perimeter (380) is substantially the same as the base perimeter (120) and the third liner bottom surface (379) is adjacent to the third sieving surface (348), and the third liner securing receptacles (372) releasably cooperate with the posts (113);
(C) the fourth layer has a fourth sieve (440) and a fourth liner (470), wherein
(i) the fourth sieve (440) has at least as many fourth sieve securing receptacles (442) as posts (113), a fourth sieving surface (448), a fourth sieve bottom surface (449), and a fourth sieve perimeter (450), wherein the fourth sieve perimeter (450) is substantially the same as the base perimeter (120) and the fourth sieve bottom surface (449) is adjacent to the third liner granule contact surface (378), and the fourth sieve securing receptacles (442) releasably cooperate with the posts (113), and
(ii) the fourth liner (470) has at least as many fourth liner securing receptacles (472) as posts (113), a fourth granule contact surface (478), a fourth liner bottom surface (479), and a fourth liner perimeter (480), wherein the fourth liner perimeter (480) is substantially the same as the base perimeter (120) and the fourth liner bottom surface (479) is adjacent to the fourth sieving surface (448), and the fourth liner securing receptacles (472) releasably cooperate with the posts (113);
(D) the fifth layer has a fifth sieve (540) and a fifth liner (570), wherein
(i) the fifth sieve (540) has at least as many fifth sieve securing receptacles (542) as posts (113), a fifth sieving surface (548), a fifth sieve bottom surface (549), and a fifth sieve perimeter (550), wherein the fifth sieve perimeter (550) is substantially the same as the base perimeter (120) and the fifth sieve bottom surface (549) is adjacent to the fourth liner granule contact surface (478), and the fifth sieve securing receptacles (542) releasably cooperate with the posts (113), and
(ii) the fifth liner (570) has at least as many fifth liner securing receptacles (572) as posts (113), a fifth granule contact surface (578), a fifth liner bottom surface (579), and a fifth liner perimeter (580), wherein the fifth liner perimeter (580) is substantially the same as the base perimeter (120) and the fifth liner bottom surface (579) is adjacent to the fifth sieving surface (548), and the fifth liner securing receptacles (572) releasably cooperate with the posts (113);
(E) the sixth layer has a sixth sieve (640) and a sixth liner (670), wherein
(i) the sixth sieve (640) has at least as many sixth sieve securing receptacles (642) as posts (113), a sixth sieving surface (648), a sixth sieve bottom surface (649), and a sixth sieve perimeter (650), wherein the sixth sieve perimeter (650) is substantially the same as the base perimeter (120) and the sixth sieve bottom surface (649) is adjacent to the fifth liner granule contact surface (578), and the sixth sieve securing receptacles (642) releasably cooperate with the posts (113), and
(ii) the sixth liner (670) has at least as many sixth liner securing receptacles (672) as posts (113), a sixth granule contact surface (678), a sixth liner bottom surface (679), and a sixth liner perimeter (680), wherein the sixth liner perimeter (680) is substantially the same as the base perimeter (120) and the sixth liner bottom surface (679) is adjacent to the sixth sieving surface (648), and the sixth liner securing receptacles (672) releasably cooperate with the posts (113);
(F) the seventh layer has a seventh sieve (740) and a seventh liner (770), wherein
(i) the seventh sieve (740) has at least as many seventh sieve securing receptacles (742) as posts (113), a seventh sieving surface (748), a seventh sieve bottom surface (749), and a seventh sieve perimeter (750), wherein the seventh sieve perimeter (750) is substantially the same as the base perimeter (120) and the seventh sieve bottom surface (749) is adjacent to the sixth liner granule contact surface (678), and the seventh sieve securing receptacles (742) releasably cooperate with the posts (113), and
(ii) the seventh liner (770) has at least as many seventh liner securing receptacles (772) as posts (113), a seventh granule contact surface (778), a seventh liner bottom surface (779), and a seventh liner perimeter (780), wherein the seventh liner perimeter (780) is substantially the same as the base perimeter (120) and the seventh liner bottom surface (779) is adjacent to the seventh sieving surface (748), and the seventh liner securing receptacles (772) releasably cooperate with the posts (113).

21. A cat litter box cleaning system (100) for hygienically removing waste clumps (20) from a plurality of litter granules (10), comprising:
a base (110) having a granule contact surface (118), a base perimeter (120), and four layer securing fixtures (112), wherein
(A) the base perimeter (120) is substantially rectangular and the base perimeter (120) has a wall (121) extending at a substantially perpendicular angle from the granule contact surface (118) to a wall height (129), wherein the wall (121) is formed with four gripping alcoves (132), the wall (121) has a proximal side (122), a distal side (124), a dextral side (126), and a sinistral side (128), and the wall height (129) measures between approximately three and approximately twelve inches, and
(B) the four layer securing fixtures (112) are posts (113) each having a layer securing fixture height (116) and a cross section (114), wherein the posts (113) are located within the base perimeter (120), and the post cross section (114) is a rectangular shape, and the securing fixture height (116) is equal to or greater than the wall height (129);
a first layer, a second layer, a third layer, a fourth layer, a fifth layer, a sixth layer, and a seventh layer, wherein
(A) the first layer has a first sieve (140) and a first liner (170), wherein
(i) the first sieve (140) has at least four sieve securing receptacles (142), a first sieving surface (148), a first sieve bottom surface (149), and a first sieve perimeter (150), wherein the first sieve perimeter (150) is substantially the same as the base perimeter (120), the first sieve bottom surface (149) is adjacent to the base granule contact surface (118), and the first sieve securing receptacles (142) releasably cooperate with the posts (113); and
(ii) the first liner (170) has at least four first liner securing receptacles (172), a first liner granule contact surface (178), a first liner bottom surface (179), and a first liner perimeter (180), wherein the first liner perimeter (180) is substantially the same as the base perimeter (120), the first liner bottom surface (179) is adjacent to the first sieving surface (148), and the first liner securing receptacles (172) releasably cooperate with the posts (113),
(B) the second layer has a second sieve (240) and a second liner (270), wherein
(i) the second sieve (240) has at least four second sieve securing receptacles (242), a second sieving surface (248), a second sieve bottom surface (249), and a second sieve perimeter (250), wherein the second sieve perimeter (250) is substantially the same as the base perimeter (120) and the second sieve bottom surface (249) is adjacent to the first liner granule contact surface (178), and the second sieve securing receptacles (242) releasably cooperate with the posts (113), and
(ii) the second liner (270) has at least four second liner securing receptacles (272), a second granule contact surface (278), a second liner bottom surface (279), and a second liner perimeter (280), wherein the second liner perimeter (280) is substantially the same as the base perimeter (120) and the second liner bottom surface (279) is adjacent to the second sieving surface (248), and the second liner securing receptacles (272) releasably cooperate with the posts (113);
(C) the third layer has a third sieve (340) and a third liner (370), wherein
(i) the third sieve (340) has at least four third sieve securing receptacles (342), a third sieving surface (348), a third sieve bottom surface (349), and a third sieve perimeter (350), wherein the third sieve perimeter (350) is substantially the same as the base perimeter (120) and the third sieve bottom surface (349) is adjacent to the second liner granule contact surface (278), and the third sieve securing receptacles (342) releasably cooperate with the posts (113), and
(ii) the third liner (370) has at least four third liner securing receptacles (372), a third granule contact surface (378), a third liner bottom surface (379), and a third liner perimeter (380), wherein the third liner perimeter (380) is substantially the same as the base perimeter (120) and the third liner bottom surface (379) is adjacent to the third sieving surface (348), and the third liner securing receptacles (372) releasably cooperate with the posts (113);
(D) the fourth layer has a fourth sieve (440) and a fourth liner (470), wherein
(i) the fourth sieve (440) has at least four fourth sieve securing receptacles (442), a fourth sieving surface (448), a fourth sieve bottom surface (449), and a fourth sieve perimeter (450), wherein the fourth sieve perimeter (450) is substantially the same as the base perimeter (120) and the fourth sieve bottom surface (449) is adjacent to the third liner granule contact surface (378), and the fourth sieve securing receptacles (442) releasably cooperate with the posts (113), and
(ii) fourth granule contact surface (478), a fourth liner bottom surface (479), and a fourth liner perimeter (480), wherein the fourth liner perimeter (480) is substantially the same as the base perimeter (120) and the fourth liner bottom surface (479) is adjacent to the fourth sieving surface (448), and the fourth liner securing receptacles (472) releasably cooperate with the posts (113);
(E) the fifth layer has a fifth sieve (540) and a fifth liner (570), wherein
(i) the fifth sieve (540) has at least four fifth sieve securing receptacles (542), a fifth sieving surface (548), a fifth sieve bottom surface (549), and a fifth sieve perimeter (550), wherein the fifth sieve perimeter (550) is substantially the same as the base perimeter (120) and the fifth sieve bottom surface (549) is adjacent to the fourth liner granule contact surface (478), and the fifth sieve securing receptacles (542) releasably cooperate with the posts (113), and
(ii) the fifth liner (570) has at least four fifth liner securing receptacles (572), a fifth granule contact surface (578), a fifth liner bottom surface (579), and a fifth liner perimeter (580), wherein the fifth liner perimeter (580) is substantially the same as the base perimeter (120) and the fifth liner bottom surface (579) is adjacent to the fifth sieving surface (548), and the fifth liner securing receptacles (572) releasably cooperate with the posts (113);
(F) the sixth layer has a sixth sieve (640) and a sixth liner (670), wherein
(i) the sixth sieve (640) has at least four sixth sieve securing receptacles (642), a sixth sieving surface (648), a sixth sieve bottom surface (649), and a sixth sieve perimeter (650), wherein the sixth sieve perimeter (650) is substantially the same as the base perimeter (120) and the sixth sieve bottom surface (649) is adjacent to the fifth liner granule contact surface (578), and the sixth sieve securing receptacles (642) releasably cooperate with the posts (113), and
(ii) the sixth liner (670) has at least four sixth liner securing receptacles (672), a sixth granule contact surface (678), a sixth liner bottom surface (679), and a sixth liner perimeter (680), wherein the sixth liner perimeter (680) is substantially the same as the base perimeter (120) and the sixth liner bottom surface (679) is adjacent to the sixth sieving surface (648), and the sixth liner securing receptacles (672) releasably cooperate with the posts (113);
(G) the seventh layer has a seventh sieve (740) and a seventh liner (770), wherein
(i) the seventh sieve (740) has at least four seventh sieve securing receptacles (742), a seventh sieving surface (748), a seventh sieve bottom surface (749), and a seventh sieve perimeter (750), wherein the seventh sieve perimeter (750) is substantially the same as the base perimeter (120) and the seventh sieve bottom surface (749) is adjacent to the sixth liner granule contact surface (678), and the seventh sieve securing receptacles (742) releasably cooperate with the posts (113), and
(ii) the seventh liner (770) has at least four seventh liner securing receptacles (772), a seventh granule contact surface (778), a seventh liner bottom surface (779), and a seventh liner perimeter (780), wherein the seventh liner perimeter (780) is substantially the same as the base perimeter (120) and the seventh liner bottom surface (779) is adjacent to the seventh sieving surface (748), and the seventh liner securing receptacles (772) releasably cooperate with the posts (113);
a protective rim (800) having four rim securing receptacles (802), a rim height (808) and a rim angle (810), wherein the protective rim (800) extends from the wall (121) toward the middle of the base (110) away from the granule contact surface (118) at the rim angle (810), as measured between an intersection of a line coincident with the protective rim (800) and a line coincident with the granule contact surface (118), the four rim securing receptacles (802) releasably cooperate with the four layer posts (113), the rim height (808) measures between approximately three and approximately six inches above the wall height (129), and the rim angle (810) measures between approximately zero and approximately eighty-nine degrees with respect to the granule contact surface (118); and
a storage cover (900) having a storage cover height (910) and a storage cover support edge (920) wherein the storage cover height (910) is greater than the layer securing fixture height (116) plus the rim height (808), wherein the storage cover support edge (920) encircles the base (110) when the storage cover (900) is positioned over the base (110), thereby the storage cover (900) substantially prevents access to the litter granules (10) when in position.

22. The cat litter box cleaning system (100) of claim 21, wherein the base (110) has a liner storage compartment (130) to releasably house the second liner (270), the third liner (370), the fourth liner (470), the fifth liner (570), the sixth liner (670), and the seventh liner (770).
